(19) United States
(12) Patent Application Publication
(10) Pub. No.: US 2009/0258598 A1
(43) Pub. Date: Oct. 15, 2009

(54) METHOD AND APPARATUS FOR PROVIDING A WIRELESS DISPLAY CONTROL UNIT

(76) Inventors: Eric Shin, Norcross, GA (US); Greg Keys, Roseville, MI (US)

Correspondence Address: PATTERSON & SHERIDAN L.L.P. NJ Office, 3040 Oak Post Road, Suite 1500, Houston, TX, 77056-6582, US

(21) Appl. No.: 12/102,346

(22) Filed: Apr. 14, 2008

(51) Int. Cl. H04B 7/00; H04B 1/00

(52) U.S. Cl. 455/41.3; 340/825.25

(57) ABSTRACT

A method and apparatus for providing a migratory wireless display control unit are disclosed. For example, the wireless control unit may include a display, one or more functional buttons for selecting a source input interface of a plurality of audio devices, where at least two of the plurality of audio devices are different audio devices and a wireless transceiver for automatically communicating with the plurality of audio devices.

The present invention relates generally to control devices and, more particularly, to a method and apparatus for providing a migratory wireless display control unit.

### BACKGROUND OF THE INVENTION

Current audio technology allows a user to control a radio or receiver with a remote control within a given environment. For example, a user may listen to a car radio. The car radio may have an associated remote control that allows the user to only control the car radio with the particular associated remote control. In another environment, a user may listen to a home receiver. The home receiver may have an associated remote control that allows the user to only control the home receiver with the particular associated remote control.

However, as audio technology expands and becomes less expensive, users may own multiple audio devices in multiple environments. As described above, a unique remote control device may be associated with each audio device. Alternatively, universal remotes require that unique program codes be provided each time a new type of device or a different brand of device is controlled. As a result, a user may have numerous remote controls for a user's multiple audio devices and be overwhelmed.

### SUMMARY OF THE INVENTION

In one embodiment, the present invention provides a method and apparatus for providing a wireless display control unit. For example, the wireless control unit comprises a display, one or more functional buttons for selecting a source input interface of a plurality of audio devices, where at least two of said plurality of audio devices are different audio devices and a wireless transceiver for automatically communicating with said plurality of audio devices.

In another embodiment, the present invention provides a method for communicating with multiple audio devices via at least one wireless display control unit. The method comprises establishing a wireless communication with a first audio device via said at least one wireless display control unit. Then the method moves said at least one wireless display control unit until said first audio device is out of range. Then the method detects a second audio device different from said first audio device. Then the method concludes by automatically establishing a wireless communication with said second audio device via said at least one wireless display control unit.

In an alternate embodiment, the present invention provides a computer-readable medium having stored thereon a plurality of instructions, the plurality of instructions including instructions which, when executed by a processor, cause the processor to perform the steps of a method for communicating with multiple audio devices. When executed, the method begins by establishing a wireless communication with a first audio device. Then the method moves said computer readable medium until said first audio device is out of range. Then the method detects a second audio device different from said first audio device. Then the method concludes by automatically establishing a wireless communication with said second audio device.

In another embodiment, the present invention discloses an audio system. The audio system comprises a behind dash unit and a wireless display control unit in communication with said behind dash unit and having capability to automatically communicate with a second audio device located in a user's home, wherein said second audio device is different from said behind dash unit.

### BRIEF DESCRIPTION OF THE DRAWINGS

The teachings of the present invention can be readily understood by considering the following detailed description in conjunction with the accompanying drawings, in which:

FIG. 1 depicts an illustrative embodiment of a wireless display control unit;

FIG. 2 depicts an illustrative communications architecture of the present invention;

FIG. 3 depicts a flow diagram of a method for communicating with multiple audio devices via at least one wireless display control unit;

FIG. 4 depicts an illustrative embodiment of an alternate communications architecture of the present invention; and

FIG. 5 depicts a high level block diagram of a general purpose computer suitable for use in performing the functions described herein.

To facilitate understanding, identical reference numerals have been used, where possible, to designate identical elements that are common to the figures.

It is to be noted, however, that the appended drawings illustrate only exemplary embodiments of this invention and are therefore not to be considered limiting of its scope, for the invention may admit to other equally effective embodiments.

### DETAILED DESCRIPTION

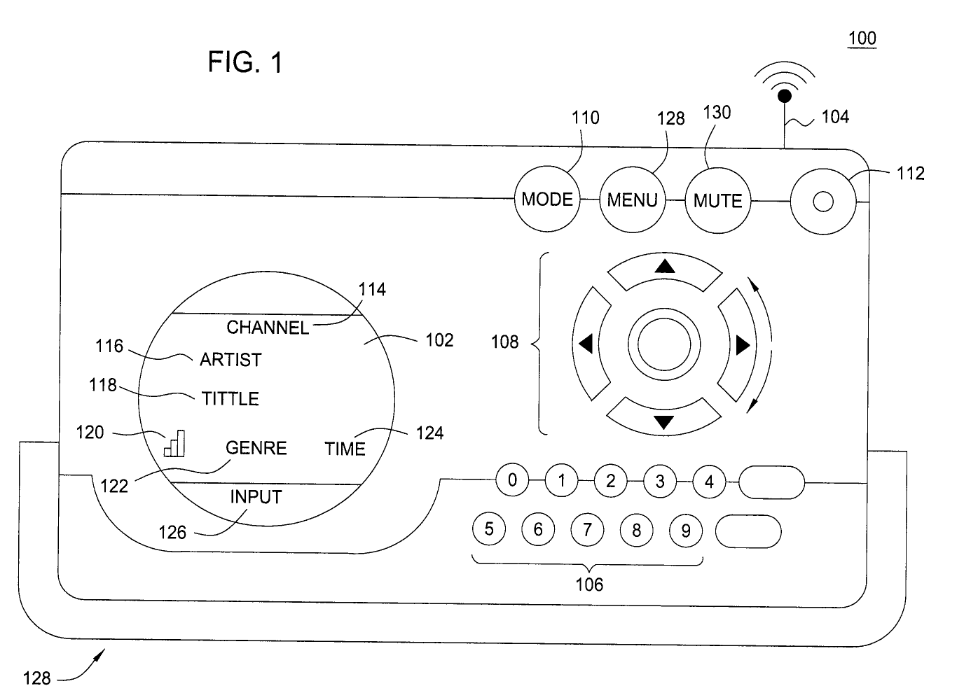

FIG. 1 depicts an illustrative embodiment of a migratory wireless display control unit (DCU) 100. The DCU 100 comprises a display 102, a wireless transceiver 104 and a plurality of functional buttons and/or knobs 106, 108, 110, 112, 128 and 130 for audio device control. For example, the functional buttons may be a bank of preset buttons 106. Although the present embodiment displays ten preset buttons, those skilled in the art will recognize that the DCU 100 may comprise any number of preset buttons. The preset buttons 106 are discussed in further detail below.

Functional buttons may also include basic control buttons 108 that include a rotary knob for navigating menus and providing music control such as seek, scan, fast forward, rewind and the like. The rotary knob provides an intuitive simple control for navigating through audio or music and/or navigating terrestrial and/or satellite radio frequencies. In addition, basic control buttons 108 may include arrowed buttons that help a user to navigate through menus or selections on the display 102.

Functional buttons may also include a mode button 110, a menu button 128 and a mute button 130. The mode button 110 is used to cycle through multiple source input interfaces of a plurality of audio devices, as will be discussed below. For example, the mode button 110 may be used to select a particular source input interface associated with a terrestrial radio input signal (e.g. HD radio), satellite input radio signal and/or a portable music player input signal. The mode button 110 may select a particular source input interface on any one of a plurality of audio devices, as will be described below.

The menu button 128 allows a user to cycle through configurable options of the DCU 100. For example, the menu button 128 allows a user to access display options, backlighting options, time zone and other clock options. Moreover, the menu button 128 may provide various configurable options depending on the current mode of the DCU 100. For example, different configurable options may be available if the DCU 100 is in a terrestrial radio mode, satellite radio mode or a portable media player mode. Functional buttons may also include a power button 112 to turn the DCU 100 on and off.

In one embodiment, the display 102 may comprise a liquid crystal display (LCD) screen. The display 102 may also be backlit.

The display 102 provides a user with various types of information. For example, the display 102 may provide information about the current song such as the current channel 114, the artist 116, title 118 and genre 122. For example, the channel 114 may indicate a tuned frequency of a terrestrial radio signal or of a satellite radio signal. The artist 116 may include information such as the name of the artist of the current song or radio program currently playing. The title 118 may include the name of the song or radio program currently playing. Additional information may be provided such as the name of the album of the current song or radio program, year of production and the like. The genre 122 may include the genre of the song or radio program currently playing, such as for example, rock, alternative, easy listening, country, soul, Christian, gospel, R&B, rap, etc.

The display may also provide technical information such as reception strength 120. In one embodiment, the reception strength 120 may be indicated by a plurality of rectangular bars of increasing height. The greater the number of bars being displayed by reception strength 120 indicates a better quality and strength of the received signal. This information may help a user decide which particular input signal to select. For example, if a user notices that the reception strength 120 for an terrestrial radio station signal is rather weak and a similar station may be found on a stronger satellite radio station signal, then the user may decide to select the satellite radio input signal via the mode button 110 of DCU 100 and tune to the appropriate satellite radio station. The display may also provide a time display 124 and which type of input signal 126 that is currently being received.

The input signal information 126 may indicate whether the user is listening to a terrestrial radio input signal (e.g. HD radio), a satellite radio input signal or a portable media player input signal (e.g., from an iPod® manufactured by Apple Inc. of Cupertino, Calif. or MP3 player). As will be discussed below, the DCU 100 may communicate with various different audio devices in various environments. Each of the various different audio devices has at least one source input interface associated with an input signal such as a terrestrial radio input signal, a satellite radio input signal or a portable media player input signal.

The bank of preset buttons 106 may be programmed or set such that each preset button of the bank of preset buttons 106 may be associated with an input signal and a channel. For example, a user may program preset button “0” to be associated with satellite radio station 50. Similarly, a user may program preset button “1” to be associated with terrestrial radio station 97.9 FM. As a result, if a user presses preset button “0”, the DCU 100 may instruct an audio device currently in communication with the DCU 100 to select the source input interface associated with the satellite radio input signal and tune the satellite radio input signal to satellite radio station 50. Then, if a user presses preset button “1”, then the DCU 100 may instruct the audio device currently in communication with the DCU 100 to select the source input interface associated with the terrestrial radio input signal and tune to the terrestrial radio input signal to station 97.9 FM. Notably, the bank of preset buttons 106 does not require a user to first manually select the desired source input interface. In other words, the bank of preset buttons 106 are programmed to automatically select a source input interface of the audio device and tune to a particular frequency of an input signal associated with the selected source input interface according to the programming of a respective preset button of the bank or plurality of preset buttons 106.

The DCU 100 may communicate with the various audio devices wirelessly via the wireless transceiver 104. For example, the DCU 100 may communicate over any wireless protocol such as for example, a BLUETOOTH® protocol of Bluetooth Special Interest Group of Bellevue, Wash. or a ZIGBEE® protocol of the ZigBee Alliance of San Ramon, Calif. In an exemplary embodiment, the wireless protocol may function on an 802.15.4 channel over a 2.4 Gigahertz (GHz) frequency.

In one embodiment, when the DCU 100 comes within range of an audio device, the DCU 100 may automatically establish communications with the audio device. In one embodiment, automatically establishing communications may include automatically synchronizing and initializing communications with the audio device via the desired wireless protocol. In other words, the user does not need to initialize the DCU 100 with any program codes when attempting to control any audio device or manually search for the presence of an audio device.

Moreover, automatically establishing communications includes selecting a channel within a range of channels that has the least amount of interference between the DCU 100 and the audio device. In one embodiment, the user may have the option to select the channel if the automatically selected channel is not acceptable to the user. Once the channel is selected, the DCU 100 may store a unique ID associated with the audio device, the selected channel. The stored unique ID may then be used to allow the DCU 100 to communicate with the audio device each time the DCU 100 comes within range of the audio device and tunes to the proper channel.

In one embodiment, the DCU 100 may store in memory a list of audio devices that the DCU 100 is allowed to control. Thus, if multiple audio devices are in range, the DCU 100 may “hunt” for audio devices that it may control. In one embodiment, if the DCU 100 finds an audio device that the DCU 100 is not authorized to control, then a user may press a button to have the DCU 100 continue hunting for other devices until the desired audio device is found by DCU 100. Once the desired audio device is confirmed by a user, the DCU 100 may automatically establish communications with the audio device as described above.

The DCU 100 may also include a recharging cradle 128. The cradle 128 may provide a power supply that may be connected either to a typical electrical outlet found in a home or in a cigarette lighter adapter in an automobile, e.g., 12 volts, 110 volts, 120 volts, etc. The cradle 128 recharges the rechargeable battery that powers the DCU 100. In one embodiment, the rechargeable battery powering the DCU 100 may be a lithium ion battery.

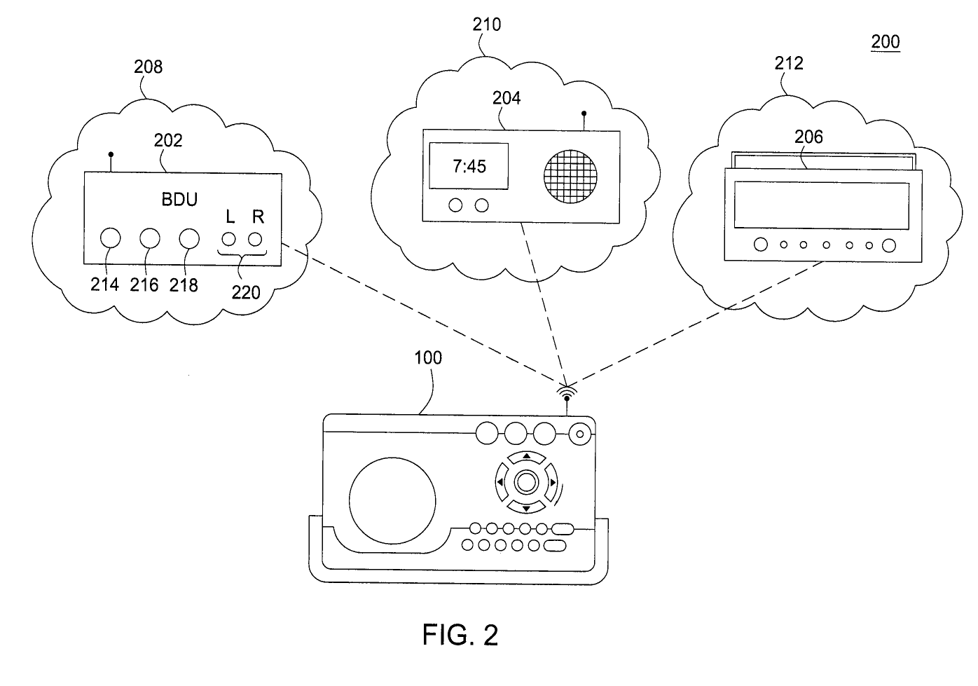

FIG. 2 depicts an illustrative communications architecture 200 of the present invention. The architecture 200 includes a DCU 100 in communications with a plurality audio devices 202, 204 and 206 in environments 208, 210 and 212, respectively.

In an exemplary embodiment, the DCU 100 may first communicate with a first audio device 202 in a first environment 208. In one embodiment, the first environment 208 may be in a user's automobile and the audio device 202 may be a behind dash unit (BDU). The BDU is a hide away black box that may be installed in a user's automobile. The BDU may comprise a plurality of source input interfaces including at least one source input interface 214 for receiving terrestrial radio input signals, at least one source input interface 216 for receiving satellite radio input signals and at least one source input interface 218 for receiving portable media player input signals. The BDU further includes an interface 220 for routing sound through the automobile's sound system. The audio devices 204 and 206 may also include similar interfaces 214, 216, 218 and 220 (not shown). The BDU is powered from the automobile's power source.

The DCU 100 may communicate with the audio device 202 (e.g. a BDU) via a wireless protocol, such as for example, ZigBee protocol. In one embodiment, the DCU 100 may establish communications with the audio device 202 using a simple media access control (SMAC) protocol. When the DCU 100 is within range of audio device 202 to detect the wireless protocol, the DCU 100 may automatically establish communications with the audio device 202. As described above, automatically establishing communications may include automatically synchronizing and initializing communications with the audio device via the desired wireless protocol. In other words, a user need not enter any program codes into the DCU 100 for compatibility with the audio device 202 or manually search for the presence of the audio device 202. These functions occur automatically between the DCU 100 and the audio device 202. Moreover, theses functions occur automatically between the DCU 100 and any type of audio device described herein, for example, a BDU, a clock radio, a home audio/video receiver, a portable audio player and the like, regardless of where the audio device is located or regardless of whether or not the DCU 100 has previously established communications with the audio device before. This allows a user to move seamlessly from one audio device to the next as will be further described below.

As a result, using the DCU 100, full audio control may be passed to any person within a user's automobile. As described above, the functional buttons 106, 108, 110, 112, 128 and 130 of the DCU 100 now allow a user to control the audio device 202 and select various source input interfaces associated with various input signals of the audio device 202. For example, the user may use the mode button 110 of the DCU 100 to select a source input interface associated with a terrestrial radio input signal, a satellite radio input signal or a portable media player input signal.

Subsequently, the user may remove the DCU 100 from the first environment 208 to stop communications with the audio device 202 and move the DCU 100 to a second environment 210 having a second audio device 204. For example in one embodiment, the user may move the DCU 100 from the user's automobile to the user's home. The second audio device 204 may be a clock radio in a user's bedroom. The clock radio may have the same interfaces as the BDU described above to allow a user to listen to terrestrial radio, satellite radio or a portable media player.

Similar to communicating with the audio device 202 in environment 208, the user may communicate with the audio device 204 in environment 210 via a wireless protocol. Also, the DCU 100 may establish communications with the audio device 204 using the SMAC protocol. Again, when the DCU 100 is within range of audio device 204 to detect the wireless protocol, the DCU 100 may automatically establish communications with the audio device 204. In other words, a user need not enter any program codes into the DCU 100 for compatibility with the audio device 204 after communicating with audio device 202 or manually search for the presence of the second audio device 204. These functions occur automatically between the DCU 100 and the audio device 204. As noted above, the user has seamlessly moved the DCU 100 from communicating with audio device 202 to communicating with audio device 204.

Now the DCU 100 has audio control of the audio device 204. As described above, the functional buttons 106, 108, 110, 112, 128 and 130 of the DCU 100 now allow a user to control the audio device 204 and select various source input interfaces associated with various input signals of the audio device 204. For example, the user may use the mode button 110 of the DCU 100 to select a source input interface associated with a terrestrial radio input signal, a satellite radio input signal or a portable media player input signal.

Further illustrating the migratory aspects of the DCU 100, the user may remove the DCU 100 from the second environment 210 to stop communications with the audio device 204 and move the DCU 100 to a third environment 212 having a third audio device 206. For example in one embodiment, the third audio device 206 may be a portable audio device that is carried outside at a park or some outdoor event. The portable audio device may have the same interfaces as the BDU described above to allow a user to listen to terrestrial radio, satellite radio or a portable media player.

Similar to communicating with the audio device 202 in environment 208, the user may communicate with the audio device 206 in environment 212 via a wireless protocol. Also, the DCU 100 may establish communications with the audio device 206 using SMAC protocol. Again, when the DCU 100 is within range of audio device 206 to detect the wireless protocol, the DCU 100 may automatically establish communications with the audio device 206. In other words, a user need not enter any program codes into the DCU 100 for compatibility with the audio device 206 after communicating with audio device 202 and 204 or manually search for the presence of the second audio device 206. These functions occur automatically between the DCU 100 and the audio device 206. Again, as noted above, the user has seamlessly moved the DCU 100 from communicating with audio device 204 to communicating with audio device 206.

Now the DCU 100 has audio control of the audio device 206. As described above, the functional buttons 106, 108, 110, 112, 128 and 130 of the DCU 100 now allow a user to control the audio device 206 and select various source input interfaces associated with various input signals of the audio device 206. For example, the user may use the mode button 110 of the DCU 100 to select a source input interface associated with a terrestrial radio input signal, a satellite radio input signal or a portable media player input signal. Advantageously, as described in the examples above, one or more of the functional buttons, e.g. the mode button 110, may be used for selecting a source input interface of a plurality of audio devices, where at least two of the plurality of audio devices are different audio devices.

In one embodiment, to prevent rouge DCU's from controlling a user's audio devices 202, 204 or 206, the DCU 100 and the audio devices may use encryption technology such that only the user's DCU 100 or other authorized DCUs 100 are able to automatically communicate with the audio devices 202, 204, 206.

In another embodiment, stored personal identification numbers (PINs) may be used to identify a user's DCU 100. For example, a PIN for each of the audio devices 202, 204 or 206 may be stored in the DCU 100. Consequently, if the PIN of the audio device 202, 204 or 206 matches one of the stored PINs in the DCU 100, then the DCU 100 and a respective audio device 202, 204 or 206 may proceed to automatically establish communications.

Alternatively, a PIN for each DCU 100 having authorization to communicate with the audio devices 202, 204 and 206 may be stored in the audio devices 202, 204 and 206. Only DCUs 100 having a PIN that matches a list of PINs stored in the each of the audio devices 202, 204 or 206 may communicate with a respective audio device 202, 204 or 206. Notably, after the encryption methodology or the PINs are established as described above, a user may seamlessly move from one audio device 202, 204 or 206 to another audio device 202, 204 or 206 without having to re-enter program codes. As a result, rouge DCUs may be prevented from having unauthorized control of a user's audio device 202, 204 or 206 while maintaining the migratory characteristics of the DCU 100.

Subsequently, the user may then move the DCU 100 back into the first environment 100 with the first audio device 202. The above embodiments are only illustrative and should not be interpreted as being limiting in any way. For example, audio devices 202, 204 and 206 may be any type of device and are not limited to the examples provided above such as, for example, a home audio/video receiver. Furthermore, the environments 208, 210 and 212 may be any environment not limited to a user's automobile and a user's home such as, for example, a park or arena using a portable audio device compatible with the DCU 100. To further illustrate, audio device 204 may be another BDU in a second user's automobile (e.g. a first user's friends automobile, a co-worker's automobile, etc.). The audio device 206 in environment 212 may be a clock radio in another family member's home. Notably, the audio devices 202, 204 and 206 need not be all owned by the same user. Furthermore, the environments 208, 210 and 212 are physically separate environments.

As a result, the present invention advantageously allows a user to carry around the DCU 100 to operate and control various audio devices in multiple different environments. Notably, the DCU 100 advantageously provides migratory features that are not currently available. In other words, the DCU 100 may be considered a migratory DCU 100 that may move from one environment having one type of audio device to the next environment having a different type of audio device and still automatically synchronize, communicate with and control any compatible audio device (i.e. any audio devices that communicate over a similar protocol and/or frequency as the DCU 100) in any environment. The need for multiple remote controls at different physical environments is eliminated. The present invention provides a “one stop shop” for all audio control needs that a user may have.

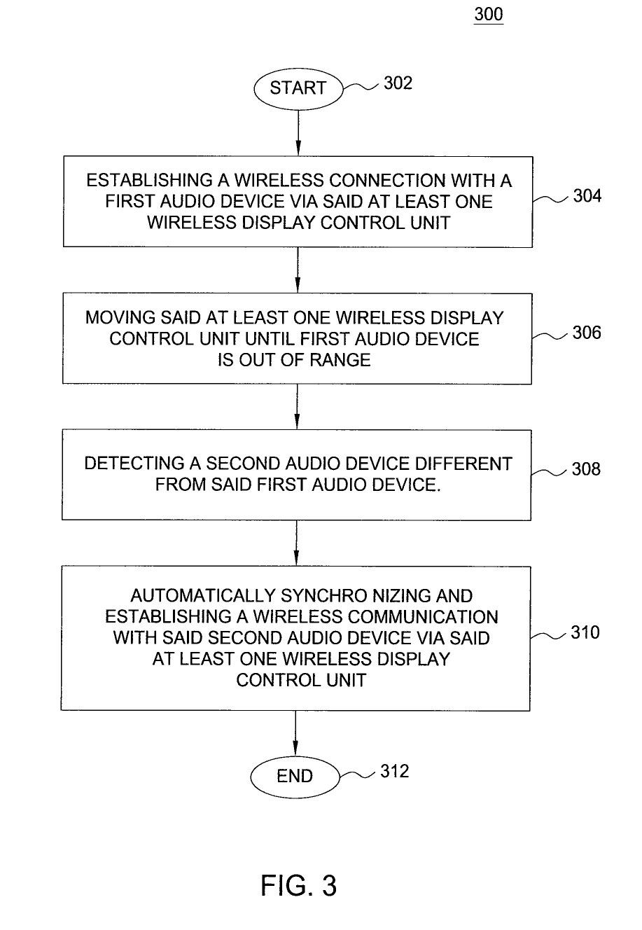

FIG. 3 depicts a flow diagram of a method 300 for communicating with multiple audio devices via at least one wireless display control unit according to one embodiment of the present invention. In one embodiment, method 300 may be executed by the DCU 100.

The method 300 begins at step 302. Then at step 304, the method 300 establishes a wireless communication with a first audio via the at least one wireless display control unit, e.g. the DCU 100. As discussed above, the first audio device may be a BDU, a home clock radio, a home audio/video receiver or a portable audio device. In one embodiment, the DCU 100 may be in a first environment, such as for example, an automobile, a home or an outdoor area. In an exemplary embodiment, the first environment may begin within a user's automobile having a BDU.

Then at step 306, the method 300 moves the at least one wireless display control unit until the first audio device is out of range. As described above, a user may remove the DCU 100 from the first environment (e.g., a user's automobile) to stop communications with the first audio device (e.g., a BDU). Alternatively, a user may manually de-select the first audio device and select a second audio device different from said first audio device to stop communications with the first audio device, as described above with respect to the “hunting” function.

Then at step 308, the method 300 detects a second audio device different from said first audio device. For example, the DCU 100 may come within range of a second audio device that is different from the first audio device. In addition, the second audio device may be located in a second environment that is different from the first environment. In one embodiment, the user may move the DCU 100 from the user's automobile into the user's home near a home audio receiver or home clock radio that is compatible with the DCU 100.

Then at step 310, the method 300 automatically synchronizes and establishes a wireless communication with said second audio via the at least one wireless display control unit, e.g., the DCU 100. As discussed above, when the DCU 100 is within range of an audio device to detect the wireless protocol, the DCU 100 may automatically synchronize and establish communications with the audio device. In other words, a user need not enter any program codes into the DCU 100 for compatibility with the audio device or manually search for the presence of the audio device. These functions occur automatically between the DCU 100 and the audio device. Moreover, theses functions occur automatically between the DCU 100 and any type of audio device described herein, for example, a BDU, a clock radio, a home audio/video receiver, a portable audio player and the like, regardless of where the audio device is located or regardless of whether or not the DCU 100 has previously established communications with the audio device before.

In addition as discussed above, the second environment may be any environment physically outside of and different from the first environment. In the exemplary embodiment, this may be any environment outside of the user's automobile. For example, the second environment may be a user's home, a different person's automobile, an outside area and the like. The second audio device may be any audio device in the second environment such as, for example, a second different BDU, a clock radio, a home audio/video receiver or a portable audio device. The method 300 concludes at step 310.

It should be noted that although not specifically specified, one or more steps of method 300 may include a storing, displaying and/or outputting step as required for a particular application. In other words, any data, records, fields, and/or intermediate results discussed in the method can be stored, displayed and/or outputted to another device as required for a particular application. Furthermore, steps or blocks in FIG. 3 that recite a determining operation or involve a decision do not necessarily require that both branches of the determining operation be practiced. In other words, one of the branches of the determining operation can be deemed as an optional step.

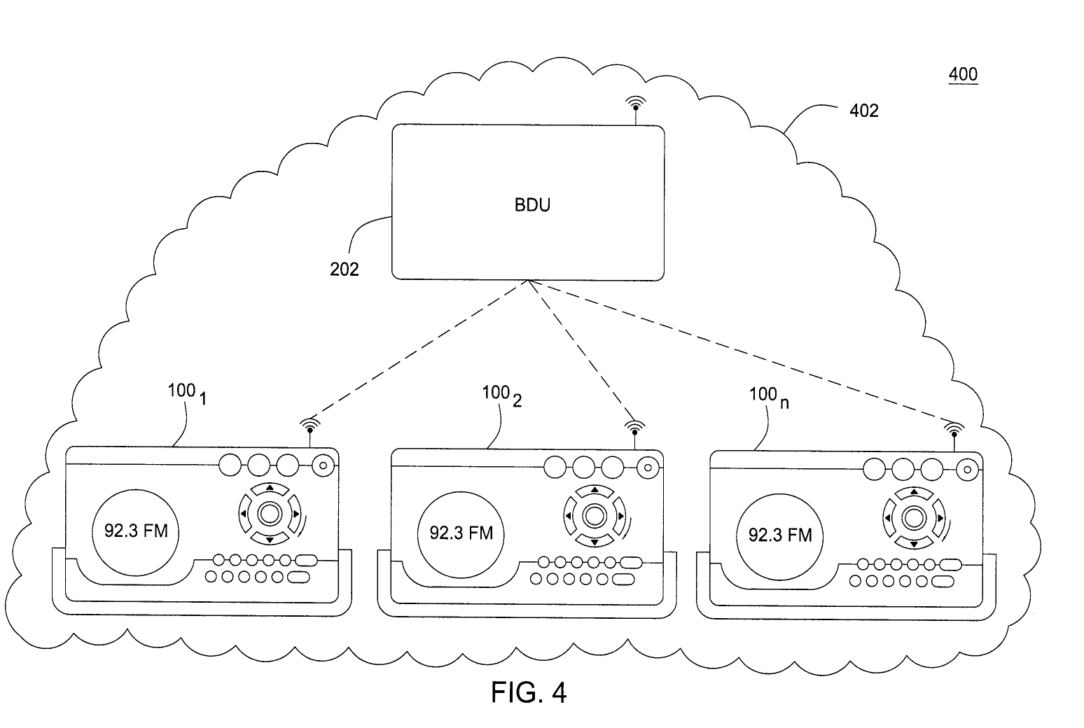

FIG. 4 depicts an illustrative embodiment of an alternate communications architecture 400 of the present invention. The architecture 400 may be explained in a single environment 402 comprising an audio device 202 (e.g. a BDU) and multiple DCUs 100₁ to 100ₙ (hereinafter also referred to collectively as DCUs 100).

The architecture 400 allows multiple DCUs 100 to simultaneously communicate with the audio device 202. To illustrate, if multiple users, each having their own DCU 100₁ to 100ₙ are in a first environment (e.g., a user's automobile), each user has the capability to communicate with the audio device 202. For example, each DCU 100₁ to 100ₙ may receive information regarding what song is currently playing, the current channel, the artist, genre, signal strength, input and current time. The information may all be displayed on each one of the respective displays of each one of the DCUs 100₁ to 100ₙ. As a result, each user having a respective DCU 100 may have complete knowledge at all times of what is currently playing without having to look at a main display console or ask another user.

Although multiple DCUs 100 may communicate with the audio device 202, the architecture 400 only allows one DCU 100 to control the audio device 202 at any time. For example, the architecture 400 may use a master slave prioritization. In one embodiment, the owner of the audio device 202 may register a serial number of the owner's DCU 100 or pre-establish a link with the audio device 202 with the owner's DCU 100 such that the owner's DCU 100 may have priority control of the owner's audio device 202 for changing channels, inputs, volume and the like. Such information may be passed between the DCU 100 and the audio device 202 via a wireless communication protocol. However, with the permission of the owner's DCU 100, priority may be passed to a different DCU owned by a different user.

In another embodiment, the architecture 400 may require a personal identification and password combination to obtain control of the audio device 202. One or more personal identifications and associated passwords may be stored in the audio device 202. For example, the audio device 202 may freely transmit information to all DCUs 100 within range. However, the audio device 202 may only accept control signals from a DCU 100 that has provided a correct pre-established personal identification and password.

Consequently, if a user is allowed access to control an owner's audio device 202 with the user's own DCU 100, then the user may change the station via the user's own DCU 100. A user knows which stations are already programmed on the user's DCU 100 bank of preset buttons 106. As a result, a user may simply press a preset button instead of manually changing the station or having to ask the owner of the audio device 202 which preset button is which channel.

To illustrate, a first user owns an audio device 202 which is normally controlled by the first user's DCU 100₁. A second user, for example a friend of the first user, enters the environment 402 where the audio device 202 is located with the second user's DCU 100₂. The first user permits the second user to take control of the audio device via the second user's DCU 100₂ either by gaining priority or providing a personal identification and password, as described above.

The first user prefers easy listening and may have programmed all of the preset buttons 106 on the DCU 100₁ to such associated channels available on terrestrial radio, satellite radio or a portable media player. However, the second user enjoys listening to rock music and the second user has programmed all of the preset buttons 106 on the DCU 100₂ to such associated channels available on terrestrial radio, satellite radio or a portable media player. As a result, when the second user gains control of the audio device 202 the second user may simply press a preset button of the bank of preset buttons 106, e.g. press preset button “1” (which is already pre-programmed or set to a rock station) to change the audio device to an associated rock station. Notably, the audio device 202 responds to the preset buttons of the second user's DCU 100₂. As a result, the present invention advantageously allows a second user to quickly and easily find and locate desired stations on another person's audio device 202.

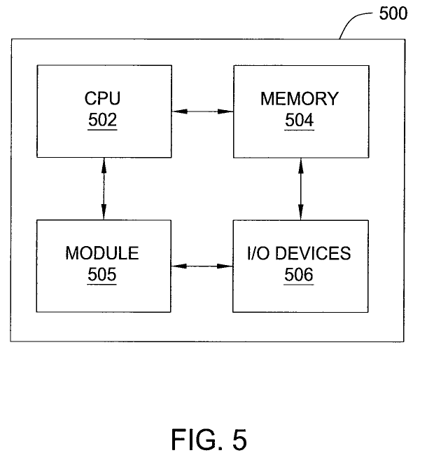

FIG. 5 depicts a high level block diagram of a general purpose computer suitable for use in performing the functions described herein. In one embodiment, the general purpose computer may be part of the DCU 100. As depicted in FIG. 5, the system 500 comprises a processor element 502 (e.g., a CPU), a memory 504, e.g., random access memory (RAM) and/or read only memory (ROM), a module 505 for communicating with multiple audio devices, and various input/output devices 506 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present module or process 505 for communicating with multiple audio devices can be loaded into memory 504 and executed by processor 502 to implement the functions as discussed above. As such, the processes provided by the module 505 for communicating with multiple audio devices (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A wireless control unit, comprising:
a display;
one or more functional buttons for selecting a source input interface of a plurality of audio devices, where at least two of said plurality of audio devices are different audio devices; and
a wireless transceiver for automatically communicating with said plurality of audio devices.

2. The wireless control unit of claim 1, wherein said wireless transceiver communicates via a ZigBee wireless protocol.

3. The wireless control unit of claim 1, wherein a first audio device of said plurality of audio devices comprises a behind dash unit.

4. The wireless control unit of claim 3, wherein said behind dash unit comprises:
at least one source input interface for receiving terrestrial radio input signals;
at least one source input interface for receiving satellite radio input signals; and
at least one source input interface for receiving mobile portable media player input signals.

5. The wireless control unit of claim 1, wherein one of said plurality of audio devices is in a first environment comprising an automobile.

6. The wireless control unit of claim 5, wherein a second audio device of said plurality of audio devices is in a second environment comprising an environment outside of said automobile.

7. The wireless control unit of claim 1, wherein a second audio device of said plurality of audio devices comprises at least one of: an audio/video receiver, a clock radio or a portable audio device.

8. The wireless control unit of claim 1, wherein said one or more functional buttons comprises:
a plurality of preset buttons, wherein each one of said plurality of preset buttons, when pressed, automatically selects a source input interface of an audio device and tunes to a particular frequency an input signal associated with a said selected source input interface according to the programming of a respective preset button of said plurality of preset button.

9. A method for communicating with multiple audio devices via at least one wireless display control unit, comprising:
establishing a wireless communication with a first audio device via said at least one wireless display control unit;
moving said at least one wireless display control unit until said first audio device is out of range;
detecting a second audio device different from said first audio device; and
automatically establishing a wireless communication with said second audio device via said at least one wireless display control unit.

10. The method of claim 9, wherein said wireless communication is via a ZigBee wireless protocol.

11. The method of claim 9, wherein said first audio device comprises a behind dash unit.

12. The method of claim 11, wherein said behind dash unit comprises:
at least one source input interface for receiving terrestrial radio input signals;
at least one source input interface for receiving satellite radio input signals; and
at least one source input interface for receiving mobile portable media player input signals.

13. The method of claim 9, wherein said first audio device is in a first environment comprising an automobile.

14. The method of claim 13, wherein said second audio device is in a second environment comprising an environment outside of said automobile.

15. The method of claim 9, wherein said second audio device comprises at least one of: an audio/video receiver, a clock radio or a portable audio device.

16. The method of claim 9, wherein a plurality of display control units are in a first environment, wherein only one of said plurality of display control units has control of said first audio device and each one of said plurality of display control units receives and displays information transmitted by said first audio device.

17. A computer-readable medium having stored thereon a plurality of instructions, the plurality of instructions including instructions which, when executed by a processor, cause the processor to perform the steps of a method for communicating with multiple audio devices, comprising:
establishing a wireless communication with a first audio device;
moving said computer readable medium until said first audio device is out of range;
detecting a second audio device different from said first audio device; and
automatically establishing a wireless communication with said second audio device.

18. An audio system comprising:
a behind dash unit; and
a wireless display control unit in communication with said behind dash unit and having capability to automatically communicate with a second audio device located in a user's home, wherein said second audio device is different from said behind dash unit.

19. The system of claim 18, wherein said wireless display control unit comprises:
a display;
one or more functional buttons for selecting a source input interface of a plurality of audio devices, where at least two of said plurality of audio devices are different audio devices; and
a wireless transceiver for automatically synchronizing with said behind dash unit and said second audio device.

20. The system of claim 18, wherein said behind dash unit comprises:
at least one source input interface for receiving terrestrial radio input signals;
at least one source input interface for receiving satellite radio input signals; and
at least one source input interface for receiving mobile portable media player input signals.
